(19) United States
(12) Patent Application Publication
(10) Pub. No.: US 2003/0000797 A1
(43) Pub. Date: Jan. 2, 2003

(54) Coin denomination distinguishing method and apparatus

(76) Inventors: William Shuie, Tao Yuan city (TW); Chuang-Kuo Chiu, Tao Yuan Hsien (TW)

Correspondence Address: RABIN & CHAMPAGNE, P.C., 1101 14 Street, N.W., Suite 500, Washington, DC, 20005, US

(21) Appl. No.: 09/892,554

(22) Filed: Jun. 28, 2001

(51) Int. Cl. G07D 5/02

(52) U.S. Cl. 194/337

(57) ABSTRACT

A coin denomination distinguishing apparatus that can initialize reference denominations, comprising: a circuit board on which there is installed an arched conductive strip and plurality of contact segments concentric with the conductive strip; the contact segments are queued in different serial numbers, define the first contact segment as a start point, divide the rest into several groups and connect the contact segments with each other of the same group; a sweep concentric with the conductive strip that can glide along an imaginary arched path and can contact the conductive strip and one of plurality of contact segments; the apparatus can select the corresponding measurement of the maximum serial number when the sweep contacts plurality of contact segments and initialize a reference denomination with the initializing and choice unit when first use.

### FIELD OF INVENTION

The present invention relates to a coin distinguishing and saving system, especially the coin denomination distinguishing method and apparatus that can initialize reference denominations applicable to coin keeper.

### BACKGROUND OF INVENTION

U.S. Pat. No. 4,998,611 is an prior invention of William Shuie who is the inventor among this invention, which discloses a coin distinguishing mechanism for a coin keeper, comprising: one detection means, one circuitry and one display means. The detection means gets the signal via a mechanical apparatus and sends the signal to the circuitry, the output result will be shown on the display means. The detection means has a passageway defined by two flat opposite walls to detect diameter of inserted coins, wherein one of which is a fixed wall and the other is a movable wall The two walls are spaced from each other by a distance less than the diameter of a smallest coin. In the detection means there is also an arm to be actuated at one end by the movable wall that is affixed to a rack gliding along an arched conductive strip. On the arm there is also fixed a pinion engaging to the rack. And there is also a conductive wiper on the arm. The circuitry comprises an arched conductive strip and plurality of contact segments lined in an arc. Once the conductive wiper contacts a certain contact segment, it will generate a signal and send to the circuitry to process.

The above-mentioned apparatus enables accurate distinguishing of the micro difference in diameters of coins inserted into the passageway of the fixed wall and movable wall by the magnifying measurement of the attached arm. However, since the diameters and denominations of coins of each country vary from each other greatly, it makes the design of conductive wiper and contact segment very complicated and therefore causes complicated specifications and enhances product cost. Although many orders have been given to the coin distinguishing mechanism for a coin keeper, it ceased to produce because of complicated specifications as well as of high product cost. However, it is very hard to invent a kind of detection means of low cost yet applicable to coins of various countries. Inventors have studied a variety of coin distinguishing methods and apparatus but failed to find one that meets this demand.

### SUMMARY OF THE INVENTION

The object of the present invention is to provide a coin denomination distinguishing method that can initialize reference denominations applicable to coin keeper that can reduce product cost of coin distinguishing apparatus and applicable to coins of various countries.

Another object of the present invention is to provide a coin distinguishing apparatus and circuit board that can initialize reference denominations applicable to coin keeper.

The present invention provides a coin distinguishing method and apparatus that can initialize reference denominations. The present invention comprising. a circuit board on which there is installed an arched conductive strip and plurality of contact segments lined in an arc concentric with the conductive strip; a sweep concentric with the conductive strip that can glide along an imaginary arched path and that can contact the conductive strip at one end and one of the plurality of contact segments lined in an arc at the other end; an initializing and choice unit with a microprocessor that is connected with the circuit board and the sweep; queue the plurality of contact segments lined in an arc into different serial numbers in succession; define the first contact segment as the start point and the following into several different groups, contact segments of each group are connected with each other; define a reference denomination with the initializing and choice unit according to the signal corresponding to the maximum serial number when the sweep contacts plurality of contact segments lined in an arc.

Once different reference denominations corresponding to different coin diameters are initialized with the initializing and choice unit and are saved in the microprocessor when first use this coin distinguishing apparatus, it can automatically distinguish denomination of each coin inserted according to its different diameter.

A preferred embodiment of the present invention is to divide all the other contact segments except the start point into three groups in succession and queue the plurality of contact segments in ascending serial numbers: 0, 1, 2, 3 . . . N, etc., in which contact segment number 0 is defined the start point, number 1 is contact segment A, number 2 is contact segment B, and number 3 is contact segment C. Divide number 1−N into three groups as follows and connect to contact segment A, B, or C respectively: contact segments whose serial numbers are 1+3n to contact segment A, those whose serial numbers are 2+3n to contact segment B and those whose serial numbers are 3+3n to contact segment C; n can be any integer between 1 and 10.

When starting to measure, a preferred embodiment is to predefine coin diameter equal to 1 and move the conductive wiper of the sweep from the start point to contact segment A. If the detected moving direction is from A to B or B to C or C to A, the measurement result is coin diameter plus 1; if not, the apparatus will detect and judge the moving direction again to see whether it is from B to A or C to B or A to C, if so, the measurement result is coin diameter minus 1; if still not, the apparatus will detect and judge the moving direction for a third time to see whether it is from A to the start point, if so, measuring is over and the apparatus will select the maximum distinguished measurement as detected coin diameter and at the same time, the conductive wiper of the sweep will be dragged by an elastic element to return to the start point. If it is not from A to the start point, it means the measuring is not over and the apparatus will detect again with the above-mentioned method.

### BRIEF DESCRIPTION OF DRAWINGS

The attached figures illustrate the preferred embodiment of this coin denomination distinguishing method and apparatus that can initialize reference denominations.

FIG. 1 is schematic of the embodiment of the structure of this coin denomination distinguishing apparatus.

FIG. 2 is schematic of the embodiment of the structure of the arched conductive strip, plurality of contact segments lined in an arc and the sweep on the circuit board of this invention.

FIG. 3 is block schematic of the embodiment of the detection means and the microprocessor of this invention.

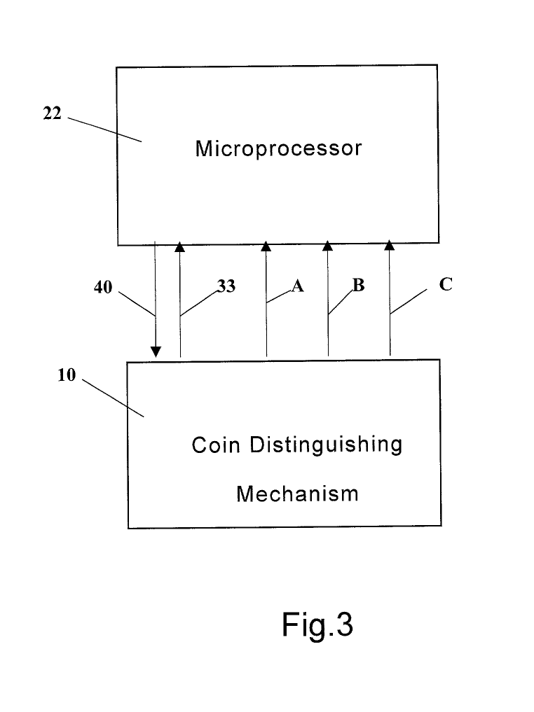

FIG. 4 is flow chart of the operation of how to detect coin denomination in this invention.

FIG. 5 is flow chart of the operation of how to initialize reference denominations in this invention.

FIG. 6 is circuit diagram of the embodiment of the microprocessor of this invention.

### DETAILED DESCRIPTION OF THE PREFERRED EMBODIMENT

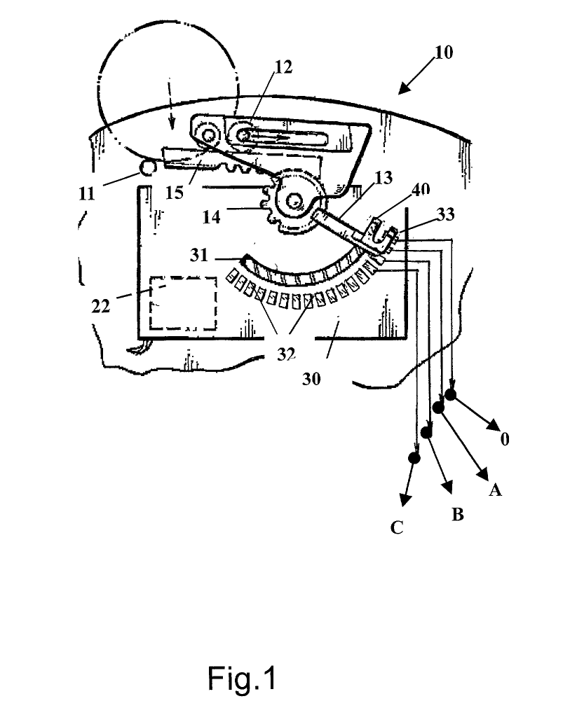

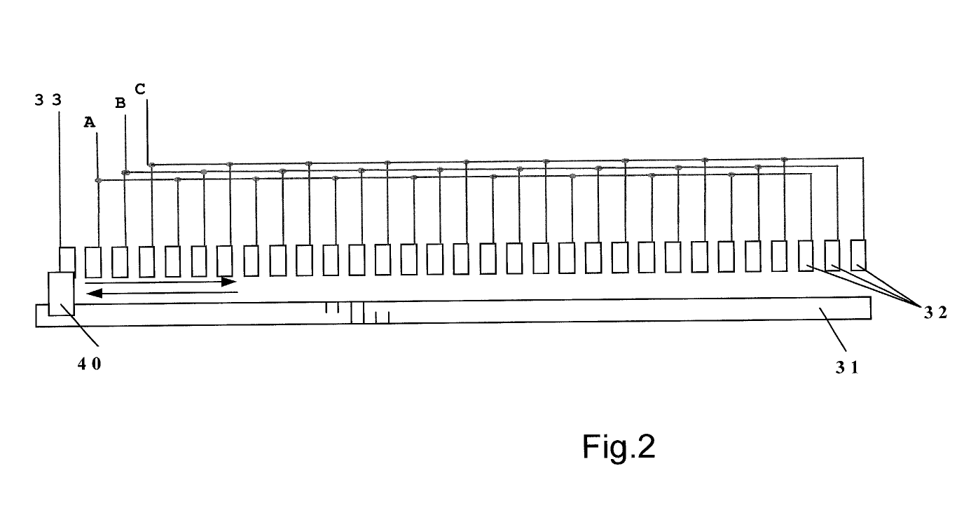

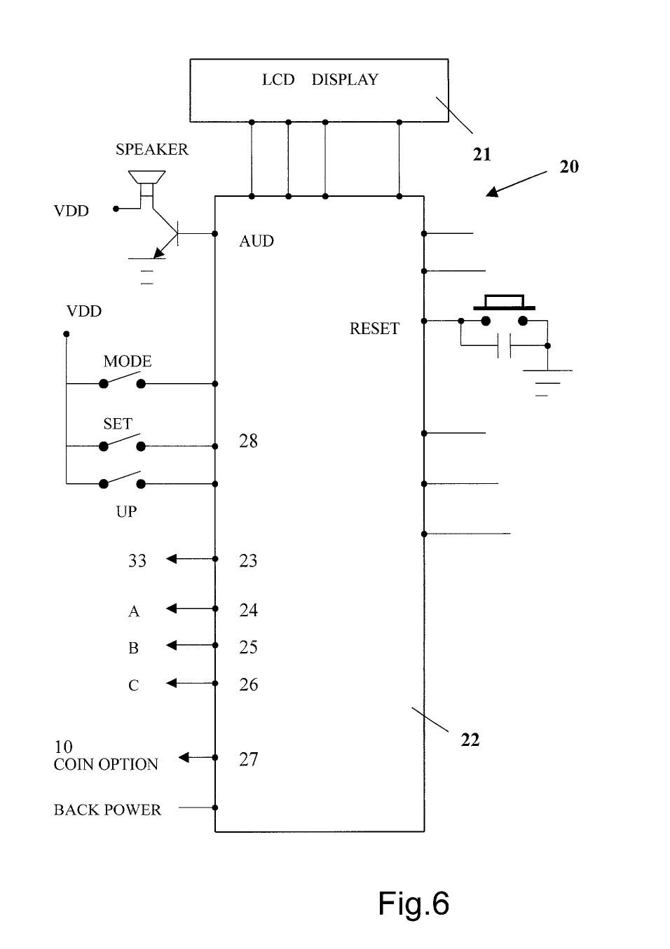

As illustrate in FIG. 1 and FIG. 2 and please refer to FIG. 1 and FIG. 6, this coin denomination distinguishing apparatus that can initialize reference denominations comprises: one detection means (10), one initializing and choice unit (20) that has a microprocessor (22) and one integrated circuitry.

The detection means (10) has a passageway for inserted coins defined by two flat opposite walls to detect coin diameter, wherein one of which is a fixed wall (11) and the other is a movable wall (12). There is an arm (13) actuated by the movable wall (12). The arm (13) is attached with a pinion (14) to which a rack (15) that can glide along a strip is engaged. The rack (15) is further affixed with the movable wall (12).

The integrated circuitry is connected to the initializing and choice unit (20). The integrated circuitry processes a display means (21) as illustrated in FIG. 6; a circuit board (30) as illustrated in FIG. 1. On the circuit board (30) there is installed an arched conductive strip (31) and plurality of contact segments (32) concentric with the conductive strip (31). The contact segments (32) are queued in equidistance. A sweep (40) concentric with the arched conductive strip (31) is affixed to the arm (13) and can glide along an imaginary arched path. The sweep can contact the conductive strip (31) and one of the plurality of contact segments (32).

As illustrated in FIG. 1 and FIG. 2, queue the plurality of contact segments (32) on the circuit board (30) together with the initializing and choice unit (20) of the microprocessor (22) into descending number N, N minus 1 (N−1), N minus 2 (N−2), etc. A preferred one is to queue them into ascending serial number 0, 1, 2, 3 . . . N, in which contact segment number 0 (33) is the start point, and all the other contact segments are divided into several groups in succession.

A preferred way to divide the contact segments is to divide all the other contact segments except the start point (33) into three groups and the contact segments of each group (32) are connected with each other as illustrated in FIG. 2. Define number 1 as contact segment A to represent group 1, number 2 as contact segment B to represent group 2, number 3 as contact segment C to represent group 3. Divide contact segments number 4 to number N (4−N) into three groups as follows and connect to contact segment A, B, or C respectively, i.e., contact segments whose serial numbers are 1 plus 3n (1+3n) to contact segment A, those whose serial numbers are 2 plus 3n (2+3n) to contact segment B and those whose serial numbers are 3 plus 3n (3+3n to contact segment C; n can be any integer between 1 and 10.

As illustrated in FIG. 6, contact segment 23 on the microprocessor (22) of the initializing and choice unit (20) is connected to the start point (33) whose serial number is 0 on the circuit board (30); contact segment 24 is connected to contact segment A whose serial number is 1; contact segment 25 is connected to contact segment B whose serial number is 2; contact segment 26 is connected to contact segment C whose serial number is 3. Contact segment 27 is connected to the detection means (10) and contact segment 28 to a denomination-initializing switch.

The present invention provides a coin denomination distinguishing method that can initialize reference denominations. As mentioned above, it comprises: one circuit board (30) on which there is installed an arched conductive strip (31) and plurality of contact segments (32) lined in an arc concentric with the conductive strip (31); one initializing and choice unit (20) with a microprocessor (22) that is connected with the circuit board and sweep; one sweep (40) concentric with the conductive strip (31) that can glide along an imaginary arched path and that can contact the conductive strip (31) at one end and one of the plurality of contact segments (32) lined in an arc at the other end;

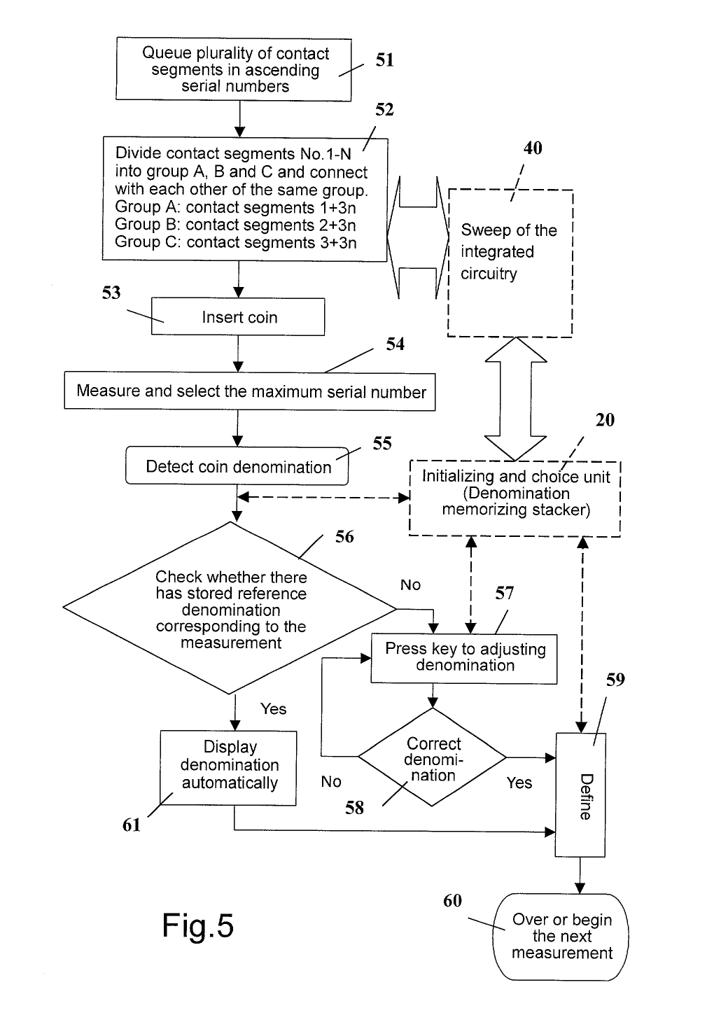

Please refer to FIG. 5, queue the plurality of contact segments into a certain serial numbers in succession (block 51); divide contact segments No. 1−N into group A, B and C and connect with each other of the same group, in which contact segments whose serial numbers are 1 plus 3n (1+3n) belong to group A, those whose serial numbers are 2 plus 3n (2+3n) belong to group B and those whose serial numbers are 3 plus 3n (3+3n) belong to group C (block 52). When the coin is inserted for the first time (block 53), the sweep (40) is actuated by the movable wall and contacts plurality of contact segments, the apparatus will then select the signal corresponding to the maximum serial number (block 54) and check the corresponding coin denomination (block 55) with those having been stored in the stacker of the initializing and choice unit (20) to judge whether the detected measurement has already had a corresponding reference denomination stored (block 56), if no, press key to adjust coin denomination (block 57) until the correct denomination comes out (block 58). Use the denomination-initializing switch of the initializing and choice unit to define a reference denomination (block 59). Repeat this procedure until all reference denominations are defined (block 60). This apparatus can automatically detect whether there has already stored corresponding reference coin denomination to any inserted coin, if yes, this apparatus can judge its denomination by its diameter and display it automatically (block 61).

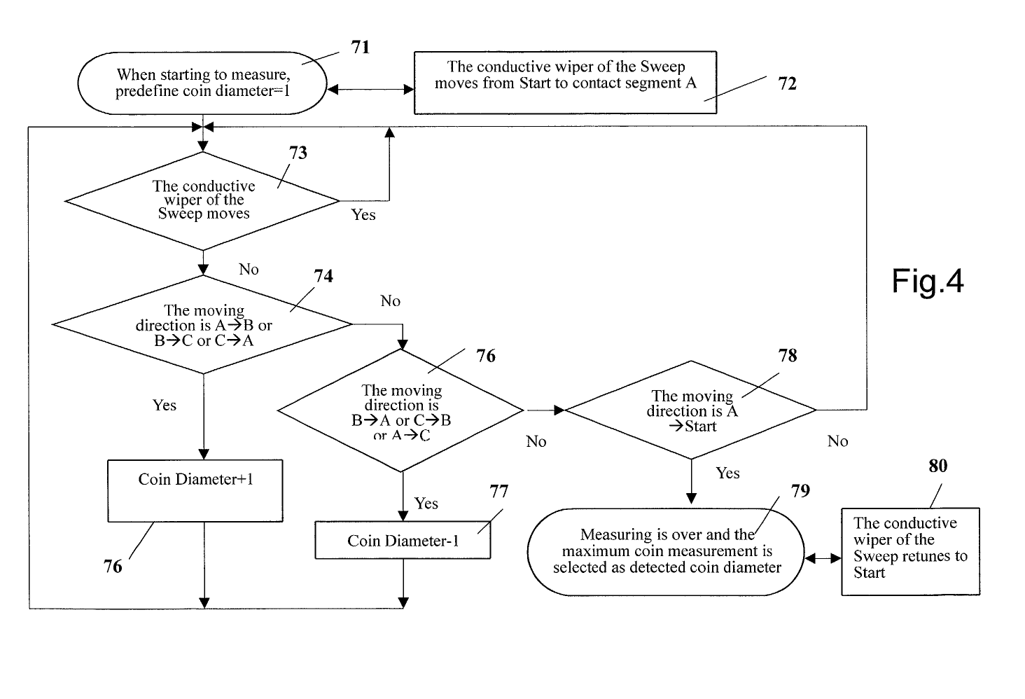

If an ascending serial number 0, 1, 2, 3 . . . N is employed, as illustrated in FIG. 4, when starting to measure, a preferred embodiment is to predefine coin diameter equal to 1 (block 71) and the conductive wiper of the sweep (40) should move from contact segment 0, i.e., the start point (33) to contact segments in group A whose serial numbers are 1 plus 3n (1+3n) (block 72) and further move to contact segments of group B whose serial numbers are 2 plus 3n (2+3n) and to contact segments of group C whose serial numbers are 3 plus 3n (3+3n) (block 73). If the conductive strip of the sweep (40) doesn't move, the apparatus will remain in detecting mode. Once a moving direction is detected from A to B, or B to C, or C to A (block 74), the measurement result is coin diameter plus 1 (block 75); if not, the apparatus will detect and judge the moving direction again to see whether it is from B to A, or C to B, or A to C (block 76), if so, the measurement result is coin diameter minus 1 (block 77); if still not, the apparatus will detect and judge the moving direction for a third time to see whether it is from A to the start point (block 78), if so, measuring is over and the apparatus will select the maximum distinguished measurement as coin diameter (block 79). Each time the coin passes the passageway defined by the movable wall (12) and the fixed wall (11), the detecting measurement can return to the initialized reference measurement and therefore cause no effect if coin is inserted incorrectly into the passageway. And after the detection is finished, the conductive wiper of the sweep (40) will be dragged by an elastic element to return to the start point (block 80). If it is not from A to the start point, it means the measuring is not over and the apparatus will detect again with the above-mentioned method.

It is to be understood that the aforegoing embodiment is described herewith for merely explaining the practicality of the present invention. There are still some variations which can be developed by taking the main idea of the present invention as basis, therefore, it is not expected to be treated as a limitation of the scope of the claims.

What is claimed is as follows:

1. A coin denomination distinguishing method comprising:
providing a circuit board on which there is installed an arched conductive strip and plurality of contact segments lined in an arc concentric with said conductive strip;
providing a sweep concentric with said conductive strip that can glide along an imaginary arched path and that can contact said conductive strip and one of said plurality of contact segments;
providing an initializing and choice unit with a microprocessor that is connected with said circuit board and said sweep;
queuing said plurality of contact segments into different serial numbers;
defining the first contact segment as a start point, the other contact segments following into several different groups, and connecting contact segments of each group with each other; and
defining a reference denomination with initializing and choice unit according to the corresponding signal generated from the maximum serial number when the sweep contacts plurality of contact segments.

2. The coin denomination distinguishing method of claim 1, further comprising defining all the other contact segments into three groups.

3. The coin denomination distinguishing method of claim 2, further comprising queuing plurality of contact segments in ascending serial numbers.

4. The coin denomination distinguishing method of claim 1, further comprising queuing plurality of contact segments in descending serial numbers.

5. The coin denomination distinguishing method of claim 3, further comprising queuing the ascending serial numbers are 0, 1, 2, 3 to N.

6. The coin denomination distinguishing method of claim 2, further comprising defining the first contact segment whose serial number is 0 as the start point, serial number 1 as contact segment A, serial number 2 as contact segment B, and serial number 3 as contact segment C; dividing serial number 4 to serial number N into three groups as follows and connecting to contact segment A, B, or C respectively according to contact segments whose serial numbers are 1+3n to contact segment A, those whose serial numbers are 2+3n to contact segment B and those whose serial numbers are 3+3n to contact segment C; and selecting wherein n from any integer between 1 and 10.

7. The coin denomination distinguishing method of claim 6, further comprising:
Predefining coin diameter equal to 1 and moving the conductive wiper of the sweep from the start point to contact segment A when starting to measure;
Setting the measurement result is coin diameter plus 1 if the detected moving direction is from segment A to B, or B to C, or C to A;
Setting the measurement result is coin diameter minus 1 if the detected moving direction is from segment B to A, or C to B, or A to C; and
Selecting the maximum distinguished measurement as detected coin diameter and making measuring over if the detected moving direction is from segment A to the start point.

8. A coin denomination distinguishing apparatus comprising:
a detection means that has a movable wall, a fixed wall, and a passageway for inserted coins defined by the movable wall and the fixed wall opposite to detect coin diameter;
an arm that is actuated by said movable wall;
an initializing and choice unit that has a microprocessor;
an integrated circuitry that is connected to said initializing and choice unit, and said integrated circuitry has a display means;
a circuit board on which there is installed an arched conductive strip and plurality of contact segments concentric with said conductive strip, wherein the first contact segment is a start point and all the other contact segments are divided into several groups and are connected with each other of the same group; and
a sweep concentric with said arched conductive strip affixed to said arm and can glide along an imaginary arched path, said sweep can contact said conductive strip and one of said plurality of contact segments.

9. The coin denomination distinguishing apparatus of claim 8, wherein said arm is attached with a pinion to which a rack that can glide along a strip is engaged and said rack is further affixed with said movable wall.

10. The coin denomination distinguishing apparatus of claim 8, wherein all the other contact segments except the first contact segment are divided into three groups.

11. The coin denomination distinguishing apparatus of claim 8, wherein the contact segments are lined in arc in equidistance.

12. A circuit board comprising: an arched conductive strip, and plurality of contact segments concentric with said conductive strip; wherein the first contact segment of said contact segments is a start point, and all the other contact segments of said contact segments are divided into several groups and are connected with each other of the same group.

13. The circuit board of claim 12, wherein all the other contact segments of said contact segments, except the first one, are divided into three groups.

14. The circuit board of claim 12, wherein the contact segments are lined in equidistance.
